(19) United States
(12) Patent Application Publication
(10) Pub. No.: US 2014/0309023 A1
(43) Pub. Date: Oct. 16, 2014

(54) Method for Providing Single-Day, Single Input, Single-Elimination Tournaments

(71) Applicants: Brent Michael Suyat, Bellevue, WA (US); Theodore Hans Kuoppamaki, Seattle, WA (US)

(72) Inventors: Brent Michael Suyat, Bellevue, WA (US); Theodore Hans Kuoppamaki, Seattle, WA (US)

(21) Appl. No.: 14/219,603

(22) Filed: Mar. 19, 2014

Related U.S. Application Data
(60) Provisional application No. 61/803,351, filed on Mar. 19, 2013.

(51) Int. Cl. A63F 13/30

(52) U.S. Cl. CPC A63F 13/12
USPC 463/29

(57) ABSTRACT

Single-day, single-elimination, bracket-based tournaments, where every tournament round is resolved simultaneously. All tournament contestants are pitted against one other contestant in a series of head-to-head random matchups where the winner is decided by their superior input and/or actions to the exact same challenge(s) as posed to all other contestants within the tournament. Tournament administrators utilize a method of resolving and determining the results for all rounds of a multi-round, bracket-based tournament simultaneously, using the single set of contestant-provided contest inputs and/or actions to determine the outcome of a single head-to-head contest. A series of head-to-head tiebreakers are incorporated to ensure that no single head-to-head contest results in a tie. Large-field, multi-round tournaments are offered and completed within a very short time period since the tournament results are dependent on a single set of contestant inputs/actions and do not require any further contestant inputs/actions in any future round.

### CROSS REFERENCE TO RELATED APPLICATIONS

This application claims priority from U.S. Patent Application Ser. No. 61/803,351, entitled “Method for Providing Single-Day, Single Input, Single-Elimination Tournaments”, filed on 19 Mar. 2012. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a method for building, offering, and administering single-day, single-elimination, bracket-based tournaments where every round in the tournament is resolved simultaneously. More specifically, this invention relates to a method of presenting, resolving and determining the results for all rounds of a multi-round, bracket-based tournament simultaneously, where each contestant is pitted against one other contestant in each round, and where the winner is determined based on their superior input and/or actions to the exact same challenge(s) as posed to all other contestants within the tournament.

### BACKGROUND OF THE INVENTION

Single-elimination tournaments are a common method to determine a single winner amongst a large number of contestants. Tournaments are generally considered to be a fair and consistent method to determine winners and an accurate ranking of other finalists, since they allow the contestants to demonstrate their skill within the rules of the game or contest against each other in head-to-head matchups.

The National Football League (NFL) and the National Collegiate Athletic Association (NCAA) for Men's Basketball, both use highly publicized, single-elimination tournaments to crown a single champion for their respective season-ending competitions. Fans of these sports frequently organize formal and informal pools to capitalize on their own knowledge of the teams involved in these season-ending tournaments, and to compete with other fans. These pools and games have become more complex and have moved from paper to computers with the development of the Internet.

As a result, numerous online games have been devised to provide fans with a method to participate in pools and make tournament picks based on their own knowledge of the games and/or contests. However, the present invention provides a more unique experience that shortens tournament durations and requires less input and actions from tournament contestants than is inherently present in the games currently offered in the prior art.

### SUMMARY OF THE INVENTION

The present invention relates generally to a method for building, offering, and administering single-day, single-elimination, bracket-based tournaments where every round in the tournament is resolved simultaneously. More specifically, this invention relates to a method of presenting, resolving and determining the results for all rounds of a multi-round, bracket-based tournament simultaneously, where each contestant is pitted against one other contestant in each round, and where the winner is determined based on their superior input and/or actions to the exact same challenge(s) as posed to all other contestants within the tournament.

The present invention focuses on streamlining the tournament contestant's experience, making the overall experience occur over a shorter period of time and requiring significantly less (e.g. none) inputs and/or actions to compete in future rounds within the tournament bracket.

In a typical and standard bracket tournament offering, winners who move on to additional rounds in the tournament are required to provide or perform a new or different set of inputs/actions for the core game or contest offering. These new inputs/actions are then evaluated against their next round opponent's new set of their respective inputs/actions for the core game or contest, and then a winner and loser are determined. These subsequent rounds in the tournament bracket often occur on a separate day and/or venue where the scoring of the game or contest is based on a different set of external factors (e.g. a different day's sporting events).

The present invention seeks to eliminate the need for contestants (who win and move on to additional rounds within a tournament bracket) to provide or perform a new or different set of inputs/actions for the core contest offering. This invention also seeks to eliminate the need for each round in a tournament to be dependent upon the evaluation and scoring of new inputs/actions from contestants who have advanced to additional rounds in the tournament. This will allow large-field, bracket-based, single-elimination tournaments to be offered and resolved over a very short time period, requiring no further action from tournament contestants, other than what is required to register and enter the tournament. Because each contestant in the tournament is presented with the exact same challenge(s) within the core game/contest(s), contestants can be fairly and randomly paired for each round of the tournament. When enough information is gathered to resolve the 1^{st} round in a tournament, no further information is required to resolve the remaining rounds in the tournament.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is an illustrative payout structure according to one embodiment of the present invention;

FIG. 2 is an illustrative bracket for a single elimination tournament according to one embodiment of the present invention;

FIG. 3 illustrates a sports betting or horse betting embodiment of the invention;

FIG. 4 is an example of a visual representation of this bracket-style tournament structure;

FIG. 5 is an example of an NBA 3-Man Challenge embodiment of the present invention;

FIG. 6 is an example of a single day, heads up tournament embodiment of the present invention;

FIG. 7 is an illustrative bracket for an 8 entrant single elimination tournament according to one embodiment of the present invention;

FIG. 8 is a screen capture of a “create games page” according to one embodiment of the present invention; and

FIG. 9 is a flow chart illustrating the process of the present invention.

### DETAILED DESCRIPTION OF THE INVENTION

In the following detailed description of the invention of exemplary embodiments of the invention, reference is made to the accompanying drawings (where like-numbers represent like-elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

A unique invention described in this document is a method to eliminate the need for tournament contestants to provide or perform a new set of input/actions for each round reached in a tournament bracket. If a contestant provides or performs an initial set of inputs/actions and registers for a tournament, those same inputs/actions are matched and evaluated against every opponent (who provides or performs an initial set of inputs/actions to the exact same challenge(s) posed in the core game) encountered in every round of the tournament the contestant reaches.

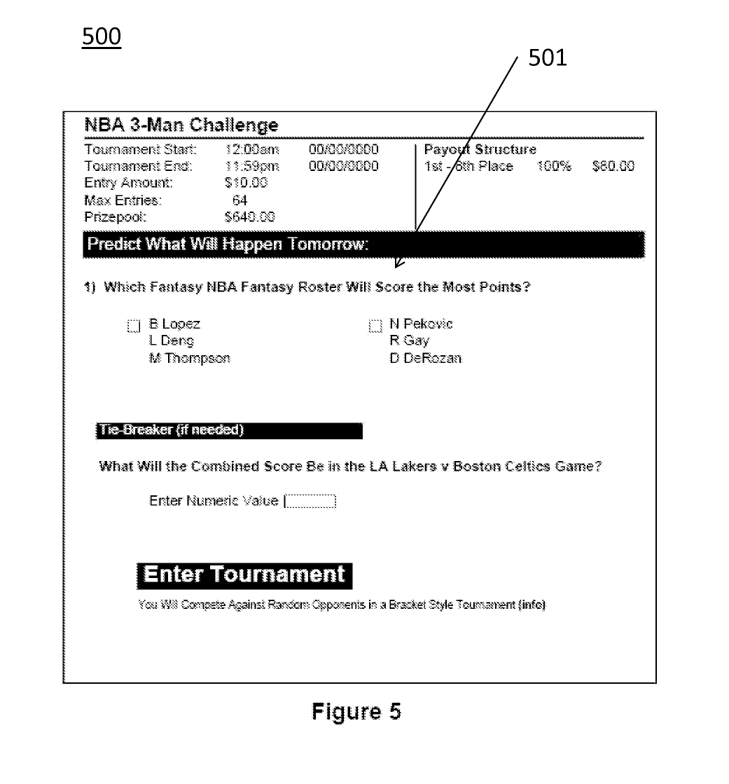

See FIG. 5 for an example of a core game 500 and the challenge(s) 501 within that are presented to each and every contestant within a tournament.

The following example game and competition is one that might be offered by the present invention: The core game is a fantasy sports football roster competition, where each contestant builds a fantasy sports roster for a single day within the sports season. The core game involves a contestant comparing their fantasy roster versus another contestant's fantasy roster, where a winner and loser are determined by evaluating accumulated statistical parameters with predefined scoring values. The game rules define how those scoring values determine the winner of the game in a head-to-head matchup.

A game or contest is an offering that allows contestants to compete in a head-to-head matchup, where a definitive winner and loser are determined after the outcome of the game or contest. These games or contests can include, but are not limited to: Fantasy Sports team/roster competitions; General Prediction Competitions, e.g. Box office results, reality show results, voting results, financial news, etc.; Sports Betting; and Horse Racing.

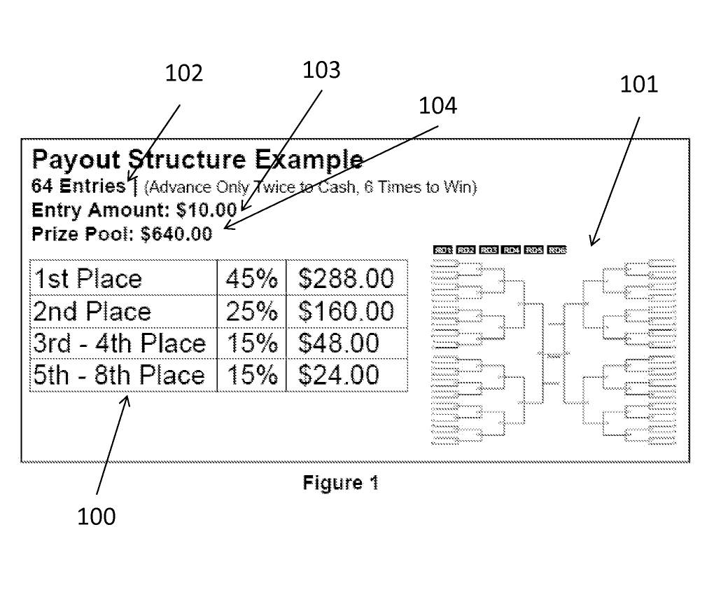

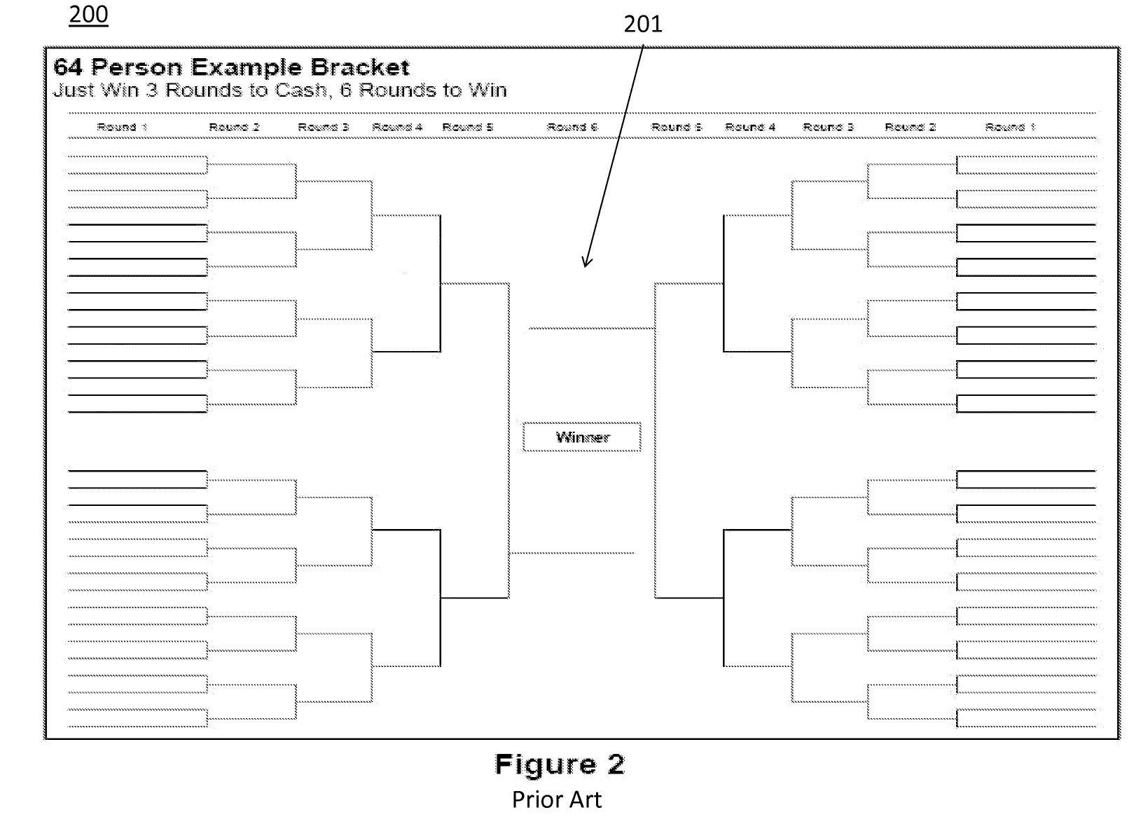

Now consider that a single-day, single-elimination, bracket-based tournament 101 is offered for this core game. Example tournament parameters: Number of entrants: 64 102; Buy-In and Entry Fee: $10.00 (or virtual coins/points or free) 103; and Prize Pool: $640 (or virtual coins/points or prizes) 104 with a Payout Structure 100 as shown in FIG. 1. This tournament would require six rounds 200 to determine a singular winner or 1^{st} place prize winner 201 as shown in FIG. 2.

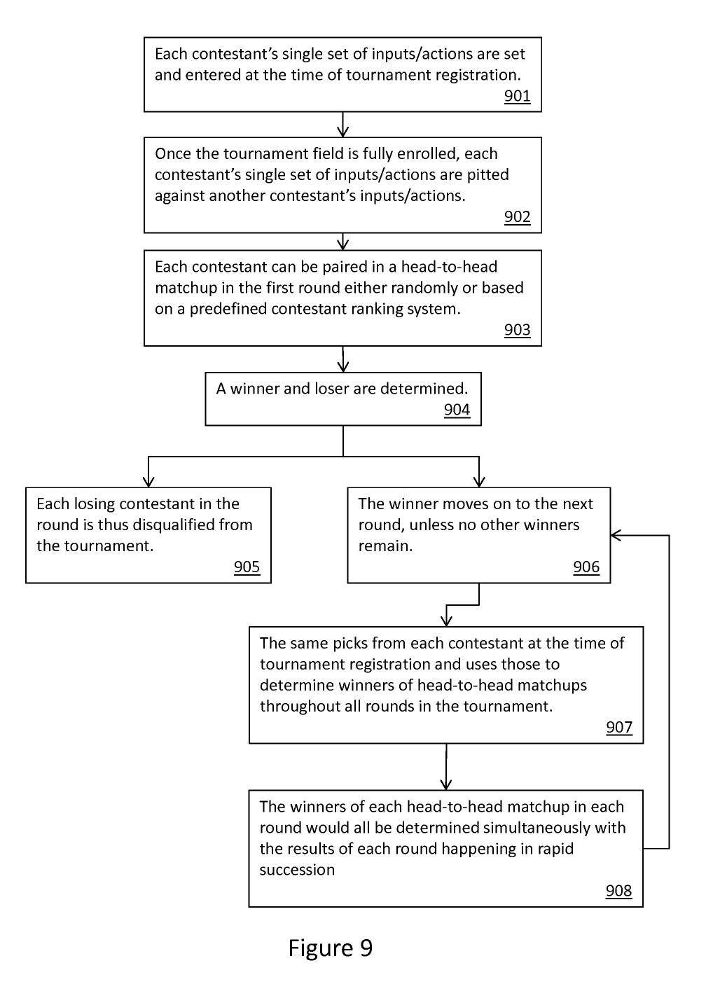

Now referring to FIG. 9, each contestant's single set of inputs/actions that are required to determine the winner for a game or contest, are set and entered at the time of tournament registration 901. Once the tournament field is fully enrolled, each contestant's single set of inputs/actions are pitted against another contestant's inputs/actions 902. Each contestant can be paired in a head-to-head matchup in the first round either randomly or based on a predefined contestant ranking system, also commonly known as tournament seeding 903.

A winner and loser are determined in each head-to-head matchup in the first round of the tournament 904. Each losing contestant in the round is thus disqualified from the tournament 906, and the winner moves on to the next round 906.

In a typical and standard bracket tournament offering, winners who move on to additional rounds in the tournament are required to provide or perform a new or different set of inputs/actions for the core game or contest offering. These new inputs/actions are then evaluated against their next round opponent's new set of their respective inputs/actions for the core game or contest, and then a winner and loser are determined. These subsequent rounds in the tournament bracket often occur on a separate day and/or venue where the scoring of the game or contest is based on a different set of external factors (e.g. a different day's sporting events).

The existing standard in administering such a tournament, is to require each contestant to make a new fantasy roster for each round in the tournament in which the contestant advances, which are then based on different real-life sporting events and statistics for each new round.

The present invention uses the same roster picks from each contestant at the time of tournament registration and uses those to determine winners of head-to-head matchups throughout all rounds in the tournament 907. The winners of each head-to-head matchup in each round would all be determined simultaneously with the results of each round happening in rapid succession 908. The user experience would be such that once all the required information to score the games is finalized, the results of all matchups and rounds in the tournament would for all intents and purposes be instantaneous to the user. Therefore, the user only needs to make one roster that will be compared and evaluated in each subsequent tournament round against new opponents, no matter how far the user advances in the tournament.

Therefore the end result for the user is an experience that is different in several ways. Just a one-time user input or action is required to enter a tournament and advance through to the final round. All tournament head-to-head matchup winners and successive tournament round results are calculated and resolved in rapid succession via computerized resolution processes, whereby making the tournament results instantaneous to the user once all the required game scoring inputs are known and entered into the tournament resolution system. Where a contestant finishes in the bracket and payout prize structure may not necessarily match what place their fantasy rosters would have finished if their roster was evaluated against all sixty-three other contestants' rosters as one large group.

In order to ensure that all rounds in tournaments resolve simultaneously, with no issues, the present invention employs a multi-tiered tiebreaker system that guarantees a clear winner and loser are determined in each and every heads-up matchup within a tournament bracket.

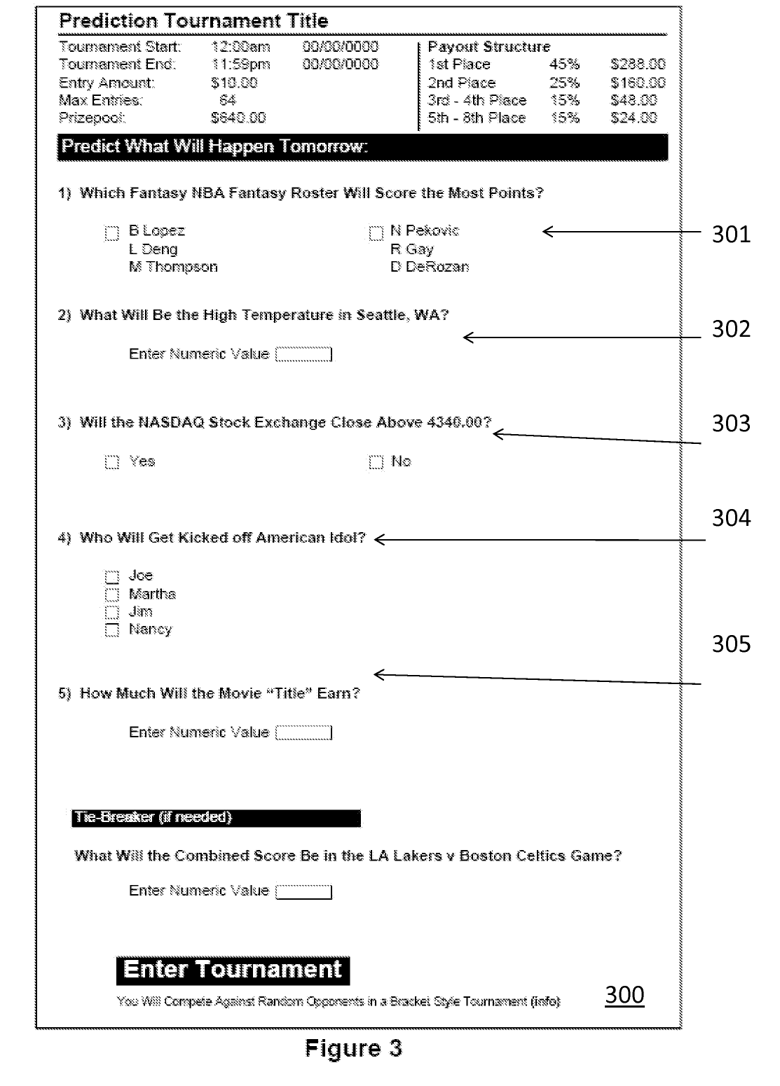

FIG. 3 illustrates a sports betting or horse betting embodiment of the invention 300. As an alternative to what are called Parlays, where a bettor makes a series of bets that are all required to win individually in order to win their bet against the “house” for a prize much larger than their original bet, a bettor can a make series of bets 301-305 that just need to beat other random opponents in order to win a large prize for their bet. In addition, in this implementation of the invention, the tournament provider can define any sort of payout structure they desire to make it more enticing and desirable for the bettors, while simultaneously eliminating risk for the “house”. This embodiment of the invention provides the following advantages over existing betting systems. It is significantly less susceptible to fraud risk and scandals involving cheating by teams, athletes, and other sporting event participants (e.g. Point Shaving). There is less risk and more potential reward to bettors due to potentially larger payout pools and a greater probability of winning some amount of prize. It eliminates the “house” exposure to drastically changing betting lines on sporting events within a short period of time.

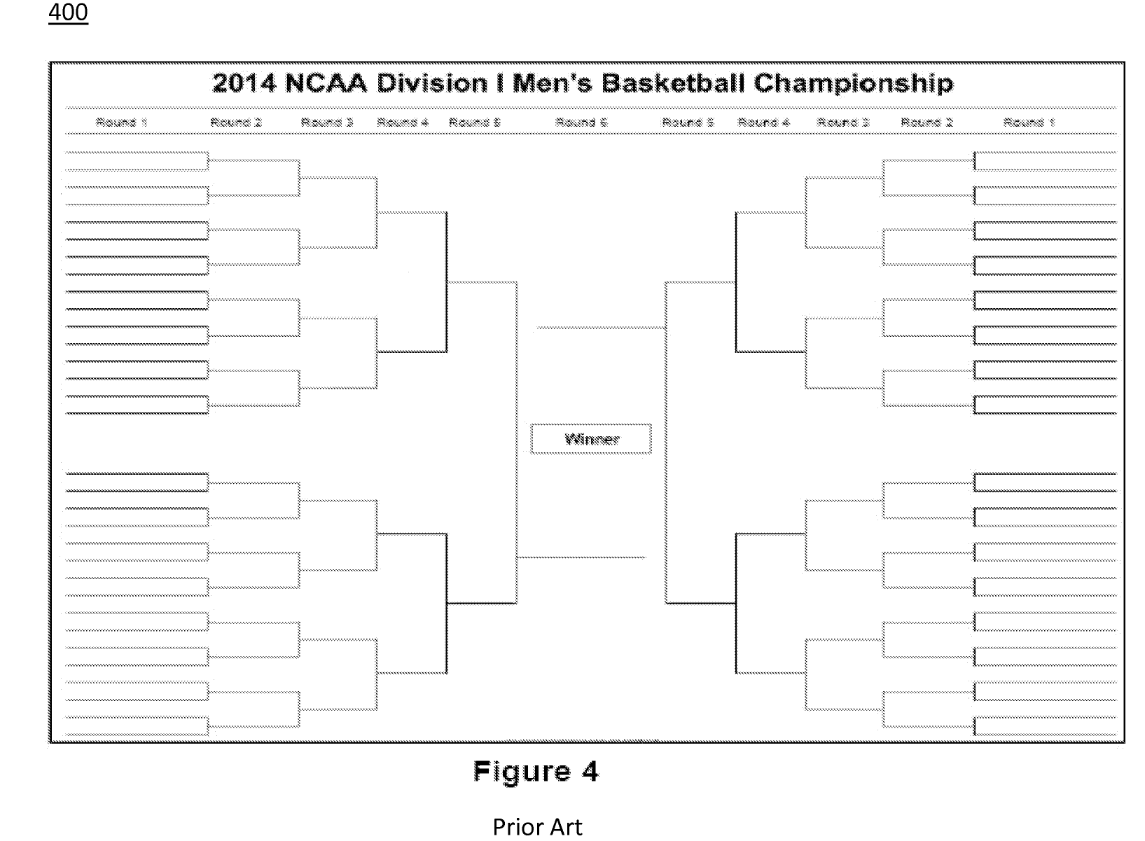

The present invention will enable the addition of a new type of contest to existing or future websites that enable bracket-style tournament structures. Specifically, this enhancement will allow the site administrator to define the following elements for a tournament: Type of Tournament; Number of entrants allowed; Buy-In and Entry Fee; Prize Pool; and Payout Structure. A traditional example of a visual representation of this bracket-style tournament structure is shown in FIG. 4 (NCAA basketball bracket 400).

In this type of tournament, contestants are randomly paired in head-to-head matchups, where the winner of each head-to-head matchup moves on to the next round to face another opponent, who has also won their way into the next round. Eventually, a singular winner is determined as illustrated in FIG. 9.

Typically, these types of tournaments span over a several day or week timespan. This specific implementation of the present invention is a variation. Instead of spanning over a several day time period encompassing several different instances of the core game, the present invention occurs and resolves in a significantly shortened timespan with the contestants making picks for a single instance of the core game.

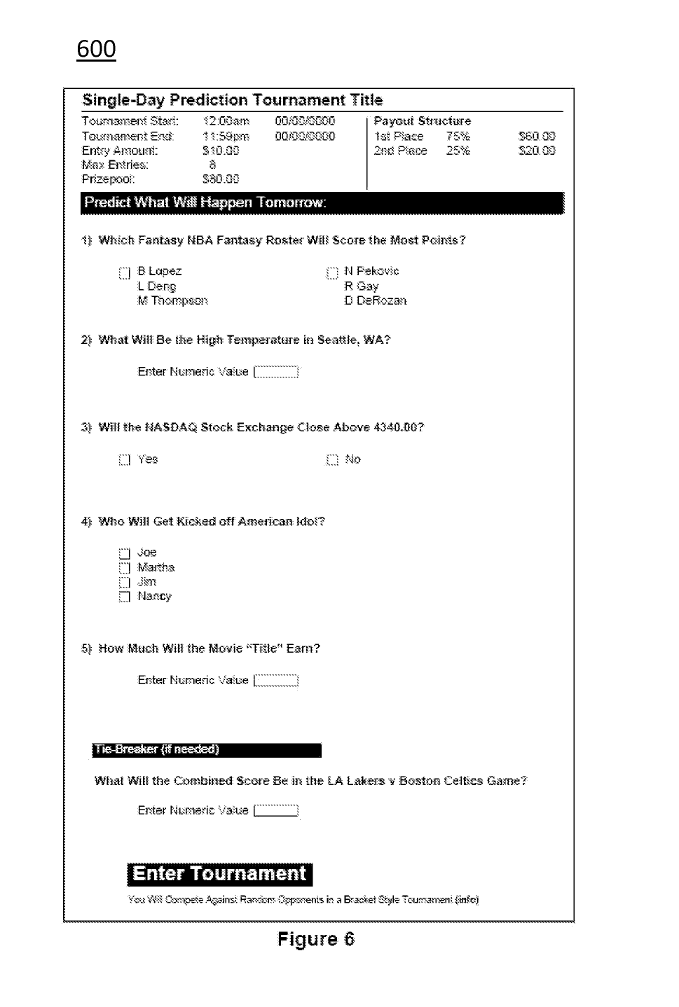

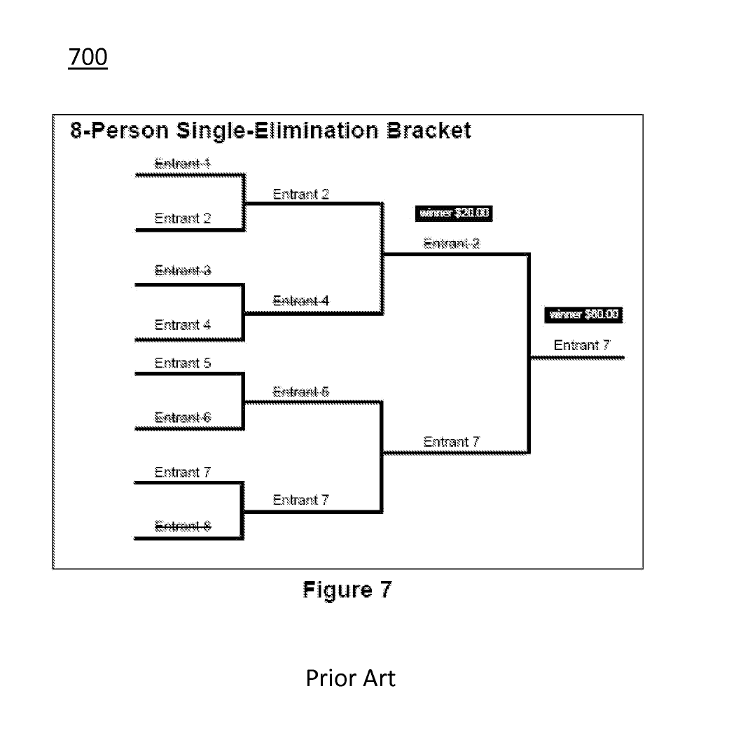

For example, consider the following defined tournament shown in FIGS. 6 and 7: Type of Tournament: Standard; Number of entrants: 8; Buy-In and Entry Fee: $10.00 (+1.00); Prize Pool: $80; and Payout Structure: $60 1^{st} Place; $20 2^{nd} Place. Each of the eight contestants will enter their picks 600 and will be randomly paired in head-to-head matchups 700 as show in FIGS. 6 and 7.

At the time of Game Resolution, the system will resolve each head-to-head matchup as shown in the single elimination bracket 700 in FIG. 7. In this example, there would be four initial head-to-head matchups in the first round, therefore there would be four total winners. The system would then randomly pair those four winners into two head-to-head matchups and resolve those heads up matches. The system would do this until there is one contestant standing (or remaining) with no more contestants to pair with as shown in FIG. 3. The system would then credit the winner with the $60 prize and the 2^{nd} place finisher would be credited $20. All other contestants in this tournament would not be credited any prizes or money.

To provide another example, let's consider a 64-person tournament: Type of Tournament: Standard; Number of entrants: 64; Buy-In and Entry Fee: $10.00 (+1.00); Prize Pool: $640; and a Payout Structure as shown in FIG. 2.

In any tournament, ties are not acceptable. The system must employ tiebreaker rules to ensure that no head-to-head contest ends in a tie.

Each tourney can allow multiple entries per single user, with the requirement that no two entries from the same user have identical tiebreaker answers, even if there are multiple tiebreaker questions.

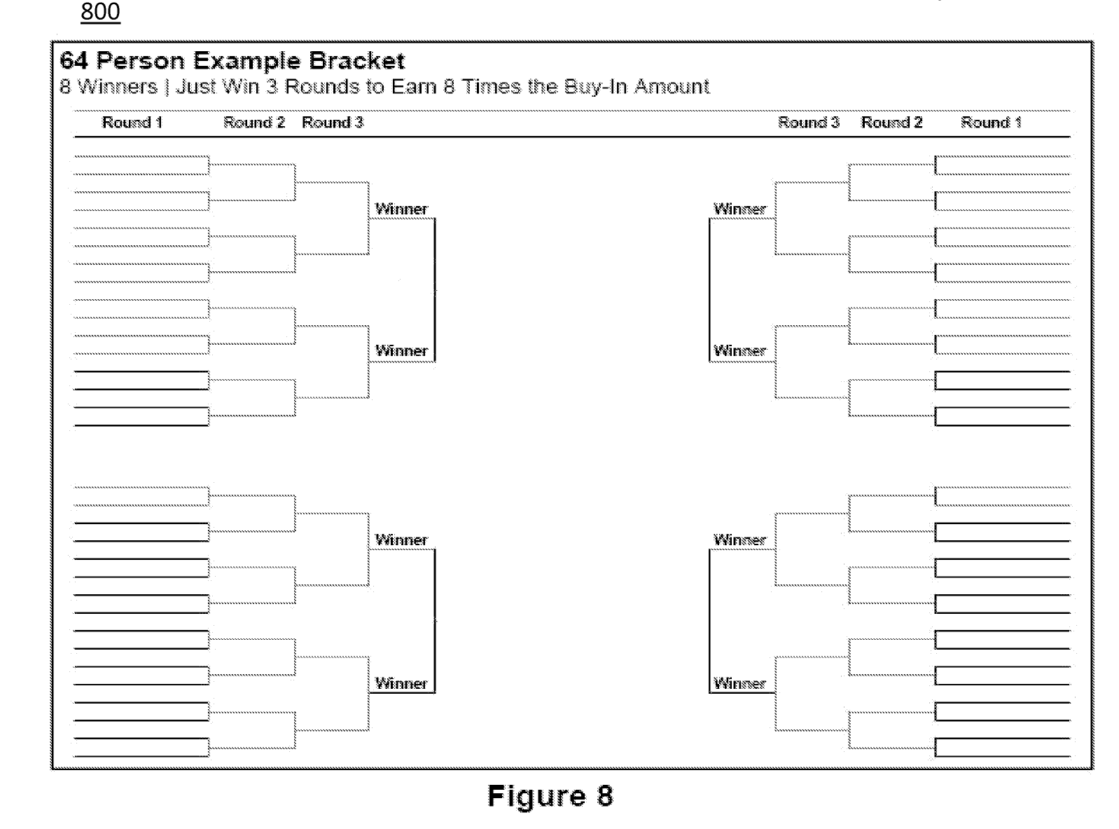

Variable payout tournaments are different from Standard tournaments in that the payout structure is different. In standard tournaments, all rounds in the single-elimination bracket must be played and resolved by the system. In variable payout tournaments, the admin defines the number of contestants that will get paid. The system only needs to resolve matchups until the defined number of players to get paid is reached. For example, in a 64-person tournament example, only 3 rounds of matches needs to be resolved, since after round three, eight people remain in the tournament. All eight get paid equal prizing. See the “64-Entrant Single Team Elimination” Tournament Bracket 800 of FIG. 8 for a visual representation and verification that after round three, eight players will remain.

Finally, here's an example of a variable payout tournament: Type of Tournament: variable payout; Number of entrants: 64; Buy-In and Entry Fee: $10.00 (+1.00); Prize Pool: $640; and Payout Structure: Final 8 receive $80. In this example, the final eight remaining contestants receive an equal share of the prize pool. In this example, each contestant would receive $80.

Although the present invention is best explained and performed for single-day, single input, single-elimination tournaments, it should be obvious to one of ordinary skill in the art that the present invention can be easily adopted to be performed over any period of time, whether that be multiple performances in one day or given time period, or set to play out over longer periods of time such as days, weeks, or months. Additionally, the tournament brackets can be double, triple, or any number of eliminations. It is well known in sports, to have double to single elimination brackets. The present invention may also incorporate a playoff game to determine 3^{rd} place finishers where a given bracket provides a first and second place finisher, but no definitive 3^{rd} and 4^{th} place finisher. A consolation or playoff elimination can be added to the tournaments in yet another alternative embodiment.

In an alternative embodiment of the present invention, several random opponent games are created for a large pool of people, and are resolved in a heads-up fashion until all losers are eliminated and just a single winner is left in each of the several random opponent games, instead of using one large contest to resolve a large pool of people down to a single winner.

The method and various embodiments taught by the present invention are set to run and/or are executed on one or more computing devices. A computing device on which the present invention can run would be comprised of a CPU, hard disk drive, keyboard or other input means, monitor or other display means, CPU main memory or cloud memory, and a portion of main memory where the system resides and executes. Any general-purpose computer, tablet, smartphone, or equivalent device with an appropriate amount of storage space, display, and input is suitable for this purpose. Computer devices like this are well known in the art and are not pertinent to the invention. The method of the present invention can also be written or fixed in a number of different computer languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. The present invention can be adapted to any situation where specific performances are measured and published. The performances are not limited to sports or financial markets. The method of the present invention can be used for or adapted to any measureable performance to create the basic contest or game taught by the present invention and embodiment by the examples given and anticipated first applications of the method.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for providing single-day, single, single-elimination tournaments, the method executed by a computer, comprising the step of:
offering a single-day, single, single-elimination tournament to a plurality of contestants;
providing or performing an initial set of inputs/actions;
registering for a tournament;
using the inputs/actions matched and evaluated against every opponent encountered in every round of the tournament the contestant reaches; and
matching and evaluating a contestant's initial set of inputs/actions against every opponent encountered in every round of the tournament the contestant reaches.

2. The method of claim 1, further comprising the steps of
building a fantasy sports roster for a single day within the sports season by one or more contestants;
comparing one contestant fantasy roster versus another contestant fantasy roster;
determining a winner and a loser by evaluating accumulated statistical parameters with predefined scoring values;
defining scoring values; and
determining a winner based on the scoring values of the game in a head-to-head matchup.

3. The method of claim 2, wherein the core game is a fantasy sports football, baseball, basketball, golf, auto racing, soccer, cricket, or hockey roster for the competition.

4. The method of claim 1, further comprising the steps of
offering that allows contestants to compete in a head-to-head matchup; and
determining a definitive winner and loser after the outcome of the game or contest.

5. The method of claim 1, wherein the games or contests are selected from one of the following group:
Fantasy Sports team/roster competitions;
General Prediction Competitions;
box office results, reality show results, voting results, financial news; sports betting; and
horse racing.

6. The method of claim 1, wherein
the number of entrants is 64; and
the tournament requires six rounds to determine a singular winner.

7. The method of claim 1, further comprising the steps of
entering each contestant's single set of inputs/actions at the time of tournament registration;
determining tournament full enrollment of players;
each contestant is paired in a head-to-head matchup in the first round;
pitting each contestant's single set of inputs/actions against another contestant's inputs/actions;
determining a winner and loser in each head-to-head matchup in the first round of the tournament;
each losing contestant in the round is thus disqualified from the tournament; and
moving the winners on to the next round.

8. The method of claim 7, wherein each contestant is paired in a head-to-head matchup in the first round.

9. The method of claim 7, wherein each contestant is paired in a head-to-head matchup in the first round based on a predefined contestant ranking system.

10. The method of claim 7, wherein each losing contestant in the round is sent to a losers bracket in a double elimination tournament, and the winner moves on to the next round.

11. The method of claim 10, wherein the single winner of the first tournament bracket faces a head to head competition with the remaining contestant in the losers bracket.

12. The method of claim 11, wherein the winner is declared in one or more head to head competitions until one of the contestants has two losses and is thus disqualified from the tournament.

13. The method of claim 1, wherein
the core game involves a contestant comparing their fantasy roster versus another contestant's fantasy roster;
determining a winner and loser by evaluating accumulated statistical parameters with predefined scoring values; and
the game rules define how those scoring values determine the winner of the game in a head-to-head matchup.

14. The method of claim 1, further comprising the steps of:
using the same roster picks from each contestant at the time of tournament registration;
using those roster picks to determine winners of head-to-head matchups throughout all rounds in the tournament;
determining simultaneously the winners of each head-to-head matchup in each round with the results of each round happening in rapid succession; and
collecting all the required information to score the games, and
determining simultaneously the results of all matchups and rounds in the tournament.

15. The method of claim 1, further comprising the steps of:
requiring a one-time user input or action to enter a tournament and advance through to the final round; and
calculating all tournament head-to-head matchup winners and successive tournament round results in rapid succession via computerized resolution processes, whereby making the tournament results instantaneous to the user once all the required game scoring inputs are known and entered into the tournament resolution system.

16. The method of claim 15, further comprising the step of:
employing a multi-tiered tiebreaker system that guarantees a clear winner and loser are determined in each and every heads-up matchup within a tournament bracket.

17. The method of claim 15, further comprising the steps of:
defining a type of tournament, either variable payout or Standard;
determining a number of entrants allowed;
setting a Buy-In and Entry Fee;
setting the Prize Pool; and
setting the Payout Structure.

18. The method of claim 17, further comprising the steps of:
resolving each head-to-head matchup;
randomly pairing those four winners into two head-to-head matchups;
resolving those heads up matches; and
repeating this process until there is one contestant standing (or remaining) with no more contestants to pair.
